(19) United States
(12) Patent Application Publication
(10) Pub. No.: US 2011/0036521 A1
(43) Pub. Date: Feb. 17, 2011

(54) Multichannel Profiled Element for Curtains, Curtain Device Comprising at Least One Multichannel Profiled Element for Curtains, and Method for Producing a Multichannel Profiled Element for Curtains

(75) Inventors: Beat Aebi, Brunnenthal (CH); Renato Burkhart, Lengnau (CH); Heinz Durig, Ostermundigen (CH); Martin Indermaur, Bern (CH)

Correspondence Address: THE WEBB LAW FIRM, P.C., 700 KOPPERS BUILDING, 436 SEVENTH AVENUE, PITTSBURGH, PA, 15219, US

(73) Assignee: SILENT GLISS INTERNATIONAL AG, Gumligen (CH)

(21) Appl. No.: 12/988,470

(22) PCT Filed: Apr. 23, 2009
(86) PCT No.: PCT/CH09/00131

§ 371 Date: Oct. 18, 2010

(30) Foreign Application Priority Data
Apr. 25, 2008 (CH) 00651/08

(51) Int. Cl. A47H 23/04; A47H 15/04; B23P 17/04

(52) U.S. Cl. 160/368.1; 29/428

(57) ABSTRACT

The invention relates to a multichannel profiled element for curtains, comprising a plurality of downwardly open guiding channels for each receiving at least one carriage. It consists of a plurality of profiled elements which each form one of the guiding channels, can be moved in the longitudinal direction of the channels, and are interconnected in a fixed manner perpendicularly to the longitudinal direction. The multichannel profiled element for curtains is suitable for a curtain device and can comprise a curved section with a comparatively small bending radius.

The invention relates to a multichannel curtain profile for a curtain device, having a plurality of downwardly open guide channels for mounting respectively at least one carriage.

A multichannel curtain profile and a curtain device having such a multichannel curtain profile have been disclosed in the prior art by CH-A-653 537 of the applicant. The multichannel curtain profile disclosed there is provided for a three-tracked flat curtain device. Three carriages, which can be moved in the rail by means of a hand draw system, are mounted on the multichannel curtain profile. The carriages are provided with stops and driver cams and respectively with a flat aluminum rail. A barbed Velcro tape, to which a curtain tape can be detachably fixed by means of a barbed Velcro tape, is fixed on the multichannel curtain profile.

Further multichannel curtain profiles and flat curtain devices are disclosed in U.S. Pat. No. 5,109,910 and DE 101 50 777 A. Such multichannel curtain profiles are generally mounted in front of a window and enable lateral displacement of curtain panels. It is frequently desired for the panels to be able to be displaced completely out of the region of the window, in order for it to be possible to look through the entire window. In the case of very wide panels, this requires a correspondingly large free space next to the window. This is also referred to as “parking” the panels. An angular profile can be used to deflect the panels, for example through 90°, next to the window and thus arrange them in front of a wall which runs at right angles to the window. Hitherto it was, however, very complicated and difficult to produce multichannel curtain profiles which are bent through a comparatively narrow radius.

The object of the invention is to provide a multichannel curtain profile which can be bent through a comparatively small radius of, for example, 90°.

The multichannel curtain profile according to the invention is characterized in that it is produced from a plurality of profiles which respectively form one of the guide channels and which can be displaced in the longitudinal direction of the channels and are fixedly connected to each other transversely to the longitudinal direction. Surprisingly, it has been shown that such a multichannel curtain profile having a comparatively small bending radius of, for example, 10 to 20 cm can be bent through an angle of 90°. In addition, the multichannel curtain profile can be bent repeatedly, for example in an S shape. The individual profiles connected to each other are comparatively narrow and can be displaced relative to each other during bending. As a result of the fixed connection transversely to the longitudinal direction, the profiles remain, however, fixedly connected to each other during and after bending. The multichannel curtain profile thus forms a unit which can be mounted like simpler profiles. Multichannel curtain profiles having, for example, up to five or more channels are possible. Five-tracked curtain devices bent for example in an S shape can thus be produced with the multichannel curtain profile. Since bending through, for example, 90° with a comparatively small radius is possible, it is also possible to park the panels or curtains on a side wall in comparatively small spaces. The multichannel curtain profile according to the invention is suitable in particular for a flat curtain device and in particular a curtain device having horizontally displaceable panels. It is, however, also possible to produce other curtain devices, for example gathered curtain devices.

According to one refinement of the invention, the profiles are respectively mechanically coupled to each other essentially over their entire length. The multichannel curtain profile can be produced in a particularly simple manner when, according to one refinement of the invention, the profiles are respectively essentially non-detachably latch-locked with each other. Alternatively, a dovetail connection is also possible. Such latch locking or dovetail connections can be produced very simply and safely, wherein the profile can be displaced in the longitudinal direction. Such profiles can be produced in particular as aluminum profiles.

The invention also relates to a curtain device having at least one multichannel curtain profile. This curtain device has a plurality of carriages, to which a curtain can respectively be fixed and which are respectively guided displaceably in one of said channels. The carriages can, for example, be moved by means of a hand draw system. Other drives, and in particular also a motorized drive, are, however, also conceivable.

The invention also relates to a method for producing a multichannel curtain profile. In this method, a plurality of profiles are connected to each other displaceably in the longitudinal direction along at least one longitudinal side and these profiles connected to each other are bent together transversely to their longitudinal extent.

Further advantageous features emerge from the dependent patent claims, the following description and the drawing.

An illustrative embodiment of the invention is explained in greater detail below with reference to the drawing, wherein:

FIG. 1 shows schematically a three-dimensional view of a portion of a curtain device according to the invention,

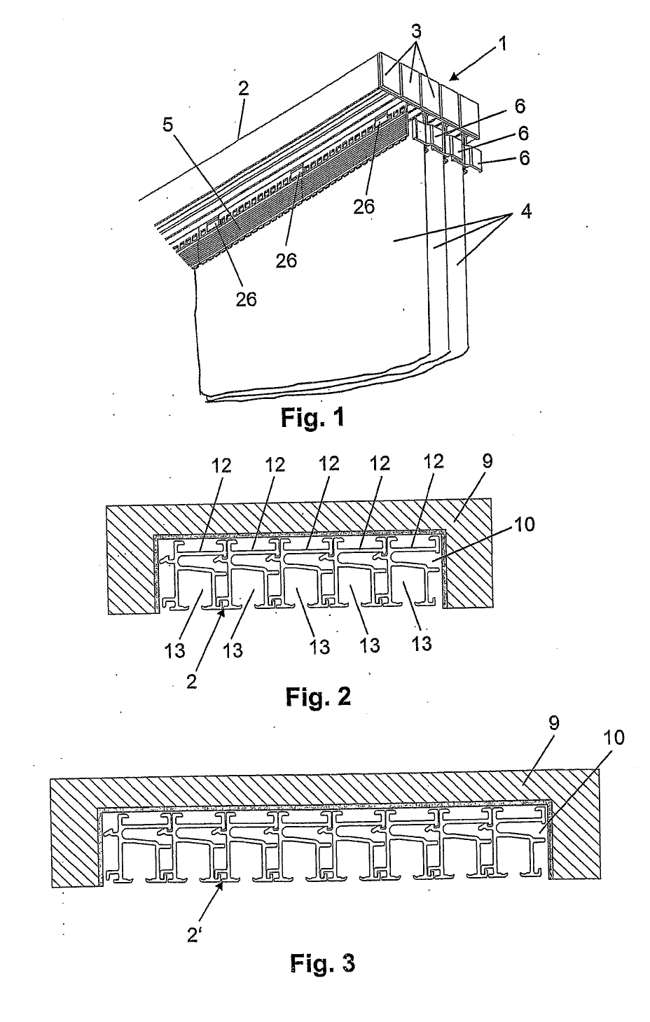

FIG. 2 shows a cross section through a mounted multichannel curtain profile,

FIG. 3 shows a section according to FIG. 2, but through a multichannel curtain profile having eight channels,

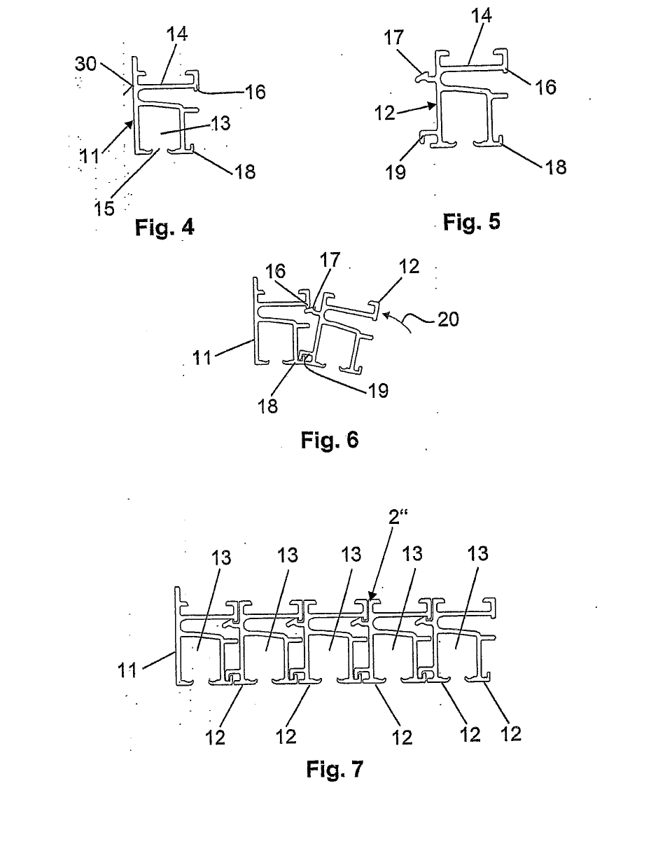

FIGS. 4 and 5 show views respectively of a profile,

FIG. 6 shows schematically the mechanical coupling of two profiles,

FIG. 7 shows a view of a multichannel curtain profile according to the invention,

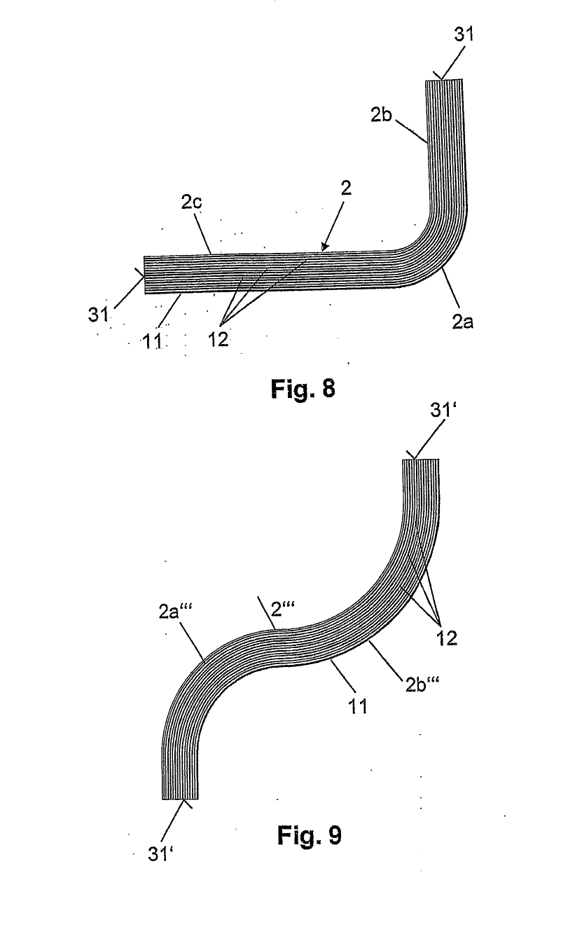

FIGS. 8 and 9 respectively show views of a curved multichannel curtain profile,

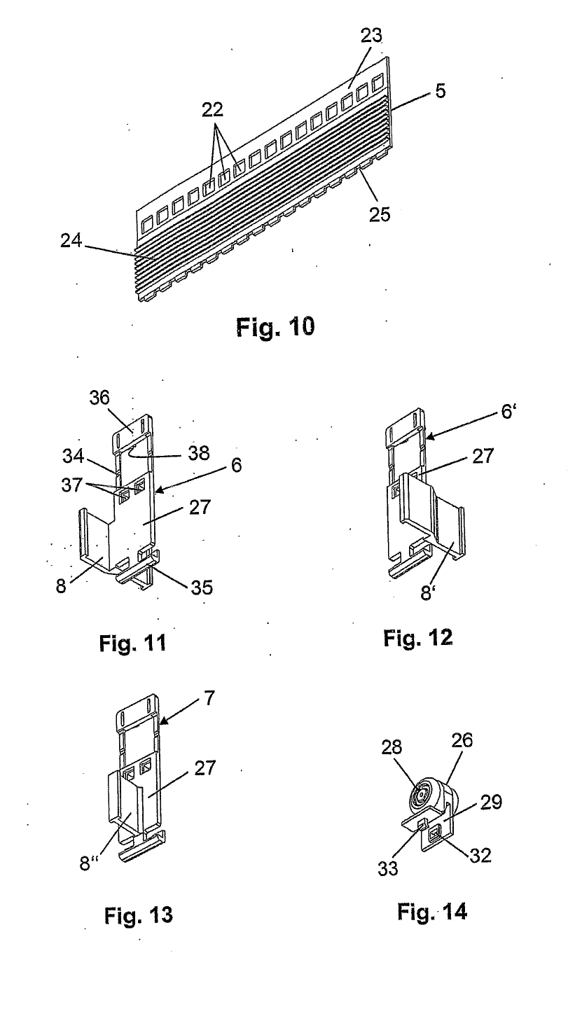

FIG. 10 shows a three-dimensional view of a carriage, wherein individual parts are omitted,

FIGS. 11 to 13 show three-dimensional views of drivers, and

FIG. 14 shows a three-dimensional view of a slide.

The curtain device 1 shown in FIG. 1 has a multichannel curtain profile 2, here shown merely in sections, which can be fixed in front of a window, for example with brackets (not shown here), to the ceiling of a building. The multichannel curtain profile 2 can be arranged, according to FIGS. 2 and 3, recessed in a niche 10 of a wall 9. This is not absolutely necessary, however. On the multichannel curtain profile 2 are mounted five carriages 5, which are displaceably guided with slides 26 in a channel 13 respectively of a profile 12, which channel is shown in FIG. 2. Detachably fixed to each carriage 5 is a curtain 4, which is comparatively wide and extends vertically. The channels 13 are closed off at the end respectively with a latched-on cover 3. To the ends of the carriages 5, a driver 6, 6′ or 7 (FIGS. 11, 12 and 13) is respectively fixed. This allows displacement of the curtains 4 in groups. In FIG. 1, the foremost curtain 4 is omitted for diagrammatic reasons. The curtains 4 can be different. They can be configured, for example, as flat curtains, or, indeed, as gathered curtains.

As already mentioned, the multichannel curtain profile consists of a plurality of profiles 12, which respectively possess a channel 13 extending in the longitudinal direction of the profiles 12. The channels 13 are respectively open at the bottom along a slot 15. In this slot 15, the slides 26 are guided. The profiles 12 are, in particular, aluminum profiles, which can be powder-coated or anodized. The profiles 12 can also, however, be made of another suitable bendable material. The profiles 12 are respectively fixedly connected to each other at the side and along their entire length. The connection between in each case two profiles 12 is preferably a mechanical connection and, in particular, a latching connection. For this purpose, the profiles 12 according to FIG. 5 possess on the left-hand side a laterally projecting latching rib 17 extending over the entire length of the profile 12 and, in a lower region, a gripping part 19, which likewise extends over the entire length and which is of hook-shaped configuration in cross section. On the right-hand side, the profiles 12 respectively possess in the upper region a downward-extending, comparatively short latching rib 16, arranged on an outer end of a web 14, and in the lower region a receiving fixture 18, which likewise extends over the entire length of the profile 12.

The multichannel curtain profile 2 according to FIG. 2 consists of five same profiles 12. The extreme left-hand profile can also be configured however, according to FIG. 4, as a profile 11. This profile 11 differs from the profile 12 by virtue of an outer plane surface 30, which forms an end surface.

FIG. 6 shows how a profile 11 is mechanically connected to a profile 12. First of all, the gripping part 19 is inserted into the receiving fixture 18. In the direction of the arrow 20, the profile 12 is now pivoted against the profile 11, so that the latching rib 17 slides along the latching rib 16 and finally back-grips the latter. The two profiles 11 and 12 are now fixedly connected along their entire lengths. At the same time, the profiles 11 and 12 can be mutually displaced in the longitudinal direction. The profiles 11 and 12 can thus slide relative to each other in the longitudinal directions. Transversely to the longitudinal direction, however, they are fixedly connected to each other. In place of the shown latching connection, another connection is also possible, for example a dovetail joint. This too allows a longitudinal displacement combined with simultaneous firm anchorage transversely to the longitudinal direction. The connection between two profiles 12 is of same configuration. The assembly is likewise realized according to FIG. 6. The profile 11 can correspondingly only be connected on one side, while the profiles 12 can respectively be connected on both sides to a further profile 12 or 11.

The multichannel curtain profile 2 consists of five profiles 12 and is thus five-tracked. The number of profiles 12 which are connected to one another is optional per se. For example, a multichannel curtain profile 2′ having eight profiles 12, as is shown in FIG. 3, is also conceivable. However, a multichannel curtain profile 2 having just two profiles 12 or 11 and is also conceivable. The multichannel curtain profile 2″ shown in FIG. 7 is made of a profile 11 and four profiles 12.

The multichannel curtain profile 2 is preferably curved and possesses, for example, according to FIG. 8, a bend 2a and a straight arm 2b, as well as a second straight arm 2c. The bend 2a is, for example, a bend of 90° or less than 90° and having a bending radius of preferably less than 50 cm, in particular 10 to 20 cm. The longer arm 2c is, in particular, that arm which extends horizontally above a window. The shorter arm 2b extends by the side of the window at right angles away from this. The length of the arm 2b roughly corresponds to the width of a curtain 4 or the length of a carriage 5. The carriages 5 can respectively be displaced along the multichannel curtain profile 2 between the two arms 2b and 2c. If the carriages 5 or the curtains 4 are located in the region of the arm 2c, then they are in front of the window (not shown here). If the carriages 5 and the curtains 4, on the other hand, are displaced into the arm 2b, then these free up the window. Of course, it is also possible for some of the carriages 5 to be located in the region of the arm 2c and for the other carriages 5 to be located in the region of the arm 2b or 2a.

FIG. 9 shows a multichannel curtain profile 2′″, which, as can be seen, is curved in an S-shape. It thus possesses two bends 2a′″ and 2b′″. Apart from the shown angular configuration according to FIG. 8 and the S-shaped configuration according to FIG. 9, other forms, for example a U-shaped form, are also possible. Types having more than two bends are also possible.

The curved multichannel curtain profiles 2 and 2′″ according to FIGS. 8 and 9 are produced by firstly connecting the profiles 12 or 11 and 12 according to FIG. 6 to form a straight multichannel curtain profile. Next, this straight multichannel curtain profile is bent into the desired shape in a bending apparatus on a corresponding mold. The profiles 12 or and 12 are here displaced in their longitudinal direction. At the ends, the profiles 12 or 11 and 12 must then be correspondingly shortened, so that plane end faces 31 and 31′ according to FIGS. 8 and 9 are formed. Finally, the still open channels 13 are closed off with the covers 3.

To enable the carriages 5 to be moved around the bends 2a or 2a′″ and 2b′″, these are highly flexible in configuration, at least in the longitudinal direction. The carriages 5 possess a flat and elongated basic element 23, which is made, for example, of a flat and comparatively thin plastic rail. In the bends 2a or 2a′″ and 2b′″, the carriages 5 can bend with corresponding elasticity. Since the carriages 5 are flexible, they respectively pass back into the straight form shown in FIG. 10.

In an upper region, rectangular or round openings 22 are incorporated in the element 23, which openings have a row of holes for fixing of the slides 26 and of the drivers 6, 6′ and 7 shown in FIGS. 11 to 13. The slides 26 can be easily mounted and latch-locked on the basic element 23. A protrusion 32 of a support 29 hereupon engages in one of the openings 22. A latching tongue 33 engages in the same opening from the other side. The slide 26 is thus, in the intended position, detachably connected to the carriage 5. On the slide 26, rollers 28 can be mounted, which allow an almost frictionless movement of the carriage 5. Slides without rollers 28 are, however, also possible. The drivers 6, 6′ or 7 respectively possess laterally protruding wings 8, 8′ and 8″, which are formed onto a bracket 27. In a lower region, a holding part 35 is additionally formed onto the bracket 27, which holding part, for fixing of the driver 6, 6′ or 7, can be engaged with a tooth system 25 of the basic element 23. The tooth system 25 is configured in the same grid pattern as the openings 22. In an upper region, two protrusions 37 are formed onto the bracket 27, which protrusions can respectively be inserted into an opening 22. Above these protrusions 37, the brackets 27 respectively possess a fixing part 36, which can be bent through 180° about a film hinge 34. Formed onto the fixing part 36 is a latching tongue (only partially visible in FIGS. 11 to 13), which, once the fixing part 36 is bent over, engages in one of the openings 22. The drivers 6, 6′ and 7 can thus be fixed very easily, and nevertheless securely, as well as detachably, to the carriage 5.

A fixing part 24 for the detachable fixing of the curtains 4 is arranged on the side of the element 23. This fixing part 24 extends over the entire length of the element 23 or of the carriage 5. The fixing part 24 is, for example, a barbed Velcro tape, which can be detachably connected to a smooth Velcro tape of the corresponding curtain 4. However, other connections are here, of course, also conceivable. The fixing part 24 may, however, also be integrally incorporated in the element 23.

### REFERENCE SYMBOL LIST

1 curtain device
2 multichannel curtain profile
2a bend
2b arm
2c arm
3 cover
4 curtain
5 carriage
6 driver
7 driver
wing
9 wall
10 niche
11 profile
12 profile
13 channel
14 web
15 slot
16 latching rib
17 latching rib
18 receiving fixture
19 gripping part
20 arrow
22 openings
23 element
24 fixing part
25 tooth system
26 slide
27 bracket
28 rollers
29 support
30 surface
31 end face
32 protrusion
33 latching tongue
34 film hinge
35 holding part
36 fixing part
37 protrusion
38 latching tongue

1-12. (canceled)

13. A multichannel curtain profile for a curtain device, having a plurality of downwardly open guide channels for mounting respectively at least one carriage, wherein it is produced from a plurality of profiles which respectively form one of the guide channels and are fixedly connected to each other at least transversely to the longitudinal direction.

14. The multichannel curtain profile as claimed in claim 13, wherein the profiles are respectively mechanically coupled to each other over their entire length.

15. The multichannel curtain profile as claimed in claim 13, wherein the profiles are respectively non-detachably latch-locked with each other or connected by means of at least one dovetail groove.

16. The multichannel curtain profile as claimed in claim 13, wherein the profiles are bent angularly in a U shape or in an S shape.

17. A curtain device having at least one multichannel curtain profile as claimed in claim 13, wherein the curtain device has a plurality of carriages which are respectively guided displaceably in one of said channels.

18. The curtain device as claimed in claim 17, wherein the carriages respectively have a flat elongated element which is highly flexible and to which a curtain can respectively be detachably fixed.

19. The curtain device as claimed in claim 17, wherein the curtain device is a flat curtain device.

20. The curtain device as claimed in claim 19, wherein the element has means for fixing slides and/or drivers.

21. A method for producing a multichannel curtain profile as claimed in claim 13, wherein a plurality of profiles are connected to each other displaceably in the longitudinal direction along at least one longitudinal side and in that these profiles connected to each other are bent together in one plane transversely to their longitudinal extent.

22. The method as claimed in claim 21, wherein the profiles are mechanically coupled fixedly to each other so that they can be displaced with respect to each other in the longitudinal direction.

23. The method as claimed in claim 21, wherein the profiles are coated, powder-coated, or anodized.

24. The method as claimed in claim 21, wherein the profiles connected to each other are bent with a bending radius of less than 100 cm, preferably less than 50 cm and more preferably with a bending radius of 10 to 20 cm.
